(19) United States
(12) Patent Application Publication
(10) Pub. No.: US 2003/0053430 A1
(43) Pub. Date: Mar. 20, 2003

(54) Method for performing a fast inter-PDSN hard handoff

(76) Inventors: Sang-Ho Choi, Taejon (KR); Kyung-Sik Kim, Taejon (KR); Sun-Bae Lim, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/026,826

(22) Filed: Dec. 27, 2001

(30) Foreign Application Priority Data
Sep. 14, 2001 (KR) 2001-56703

(51) Int. Cl. H04Q 7/00

(52) U.S. Cl. 370/331; 370/436

(57) ABSTRACT

There is provided a method for performing an inter-packet data service node (PDSN) hard handoff. The method is implemented by setting up a channel link passing through a target base station controller (T-BSC), a source base station controller (S-BSC), a source packet control function (S-PCF) and a source-PDSN (S-PDSN) by establishing a channel link between the S-BSC and the T-BSC via a mobile station center (MSC) in an active packet session mode, performing the hard handoff between the S-BSC, the T-BSC and a mobile station (MS) and transmitting or receiving user packet data exchanged between the MS and the T-BSC through the established channel link to or from the S-PDSN in case the hard handoff is completed.

### FIELD OF THE INVENTION

The present invention relates to synchronous IMT-2000 wireless packet communication networks; and, more particularly, to a method for performing a fast inter-packet data service node (PDSN) hard handoff without data loss via a mobile switching center (MSC) so as to provide high-speed/high-quality real-time data services without data loss in an active packet mode.

### DESCRIPTION OF RELATED ART

In conjunction with current integrated Internet protocol (IP) networks, an Internet protocol based wireless packet data network is standardized so as to provide Internet services and real-time VoIP services in a third generation synchronous IMT-2000 wireless access network.

In particular, there exist technical problems of header compression and a handoff in implementing the current Internet protocol based wireless packet network and these problems should be solved to obtain satisfactory QoS.

According to a standardization document IS-835 related to the third generation IMT-2000 synchronous wireless packet data network, as components constructing the wireless packet data network, there are a base station controller (BSC), a packet control function (PCF) unit, a packet data service node (PDSN), a mobile Internet protocol (IP) home agent (HA) and an authentication/authorization/accounting (AAA) unit.

Referring to FIG. 1, there is illustrated a call-processing flow diagram showing an Inter-PDSN hard handoff procedure defined in the IS-835 and IOS V4.x.

When a message showing that a signal strength of a mobile station (MS) 101 became over a given signal strength threshold defined in a network and the MS 101 will convert to another access network identifier (ANID) is transmitted from the MS 101 to a source-BSC (S-BSC) 103, the S-BSC 103 sends a Handoff Required message including a cell list within a domain of a target-BSC (T-BSC) 107 to an MSC 111 in step S101 and actuates a T7 timer. The Handoff Required message contains a previous ANID (PANID).

The MSC 111 selects the T-BSC 107 having an available wireless channel from the cell list, adds the PANID and a hard handoff indicator to a Handoff Request message and transmits the Handoff Request message to the T-BSC 107 in step S103. Herein, the hard handoff indicator means a handoff type component representing a hard handoff. After receiving the Handoff Request message, the T-BSC 107 allocates appropriate idle wireless resources and transmits null traffic channel data on a forward traffic channel.

To set up an A8-Connection, the T-BSC 107 provides an A9-Setup-A8 message to a target-PCF (T-PCF) 109 and actuates a TA8-Setup timer in step S105. Herein, the A8 is a user traffic path for BSC-PCF packet data services defined in the standardization document. The A9 represents a signal path for the BSC-PCF packet data services defined in the standardization document. In step S105, a hard handoff indicator field in the A9-Setup-A8 message is set to 1.

After receiving the A9-Setup-A8 message, the T-PCF 109 sets up the A8-Connection, transmits an A9-Connect-A8 message to the T-BSC 107 and actuates a Twaitho9 timer in step S107. At this time, the T-BSC 107 and the T-PCF 109 do not receive packet data from a source-PDSN (S-PDSN) 121 and the PDSN 121 continuously sends forward packet data to the S-BSC 103 through an S-PCF 105. Meanwhile, after receiving the A9-Connect-A8 message, the T-BSC 107 stops an operation of the TA8-Setup timer.

Since the hard handoff indicator field in the A9-Setup-A8 message was set to 1, an A10/A11 Connection is not established yet. The A10 and A11 represent traffic and signal paths for PCF-PDSN packet data services defined in the standardization document, respectively.

Then, in step S109, the T-BSC 107 allows the MS 101 to be tuned to a corresponding wireless channel by transmitting a Handoff Request Ack message including appropriate wireless channel information to the MSC 111 and actuates a T9 timer so as to wait for the signal receiving from the MS 101 through the corresponding wireless channel.

The MSC 111 prepares a call switching from the S-BSC 103 to the T-BSC 107 and delivers a Handoff Command message including the wireless channel information provided from the T-BSC 107 to the S-BSC 103 in step S111. The S-BSC 103 terminates an operation of the T7 timer.

The S-PCF 105 receives an A9-Air Link (AL) Disconnected message from the S-BSC 103 and, then, stops packet data transmission to the S-BSC 103 in step S113. After transmitting the A9-AL Disconnected message, the S-BSC 103 actuates a Tald9 timer.

In step S115, the S-PCF 105 sends an A9-AL Disconnected Ack message to the S-BSC 103 and the S-BSC 103 terminates an operation of the Tald9 timer.

In step S117, the S-BSC 103 transmits a general handoff direction message (GHDM) or a universal handoff direction message (UHDM) to the MS 101 and actuates a Twaitho timer so as to allow the MS 101 to return to the S-BSC 103.

The MS 101 provides the S-BSC 103 with an MS Ack Order message as a response to the GHDM or UHDM in step S119.

In step S121, the S-BSC 103 transmits a Handoff Commenced message to the MSC 111 so as to notify that the MS 101 is instructed to move to a channel of the T-BSC 107 and actuates a T306 timer to wait for transmission of a Clear Command message from the MSC 111. The Handoff Commenced message is transmitted after an operation of the Twaitho timer is terminated.

If the MS 101 completes the hard handoff procedure by obtaining synchronization through the use of a backward communication channel frame or preamble data, the MS 101 transmits a Handoff Completion message to the T-BSC 107 in step S123 and the T-BSC 107 which received the Handoff Completion message transmits a BSC Ack Order message to the MS 101 in step S125.

Further, in step S127, the T-BSC 107, which received the Handoff Completion message from the MS 101, provides the T-PCF 109 with an A9-AL Connected message including the PANID. The T-BSC 107 terminates an operation of the Twaitho9 timer and the T-PCF 109 actuates a Talc9 timer.

In step S128, the T-PCF 109 selects a target-PDSN (T-PDSN) 123 for a corresponding call and sends an All-Registration Request message with a mobility event indicator included in a vendor/organization specific extension to the T-PDSN 123.

If the All-Registration Request message is verified, the T-PDSN 123 accepts a connection by transmitting an All-Registration Reply message including an Accept indication to the T-PCF 109 in step S129. At this time, A10 Connection Binding information is updated to the T-PCF 109 in the T-PDSN 123.

Then, the T-PCF 109 transmits an A9-AL Connected Ack message to the T-BSC 107 as a response to the A9-AL Connected message and terminates an operation of the Talc9 timer in step S131.

After the T-BSC 107 detects that the MS 101 is connected to the T-BSC 107, the T-BSC 107 transmits a Handoff Complete message to the MSC 111 so as to notify that the hard handoff is successfully performed for the MS 101 and terminates an operation of the T9 timer in step S133.

After then, in step S134, a point-to-point (PPP) link layer connection is established between the MS 101 and the T-PDSN 123 and there is performed a mobile Internet protocol (MIP) registration procedure between the wireless packet network and the MS 101. If the registration is completed, user packet data are exchanged through the A10 Connection between the MS 101 and an opposite MS.

Referring to FIG. 2, there will be explained the PPP establishment and MIP registration procedure.

In step S135, the MSC 111, which received the Handoff Complete message, transmits a Clear Command message to the S-BSC 105. The S-BSC 105 terminates an operation of the T306 timer and the MSC 111 actuates a T315 timer.

In step S137, the S-BSC 103 sends an A9-Release-A8 message to the S-PCF 105 so as to release the A8-Connection and actuates a Trel9 timer.

The S-PCF 105 releases the A8/A10/A11-Connection in steps S138 and S140 and sends an A9-Release-A8 Complete message to the S-BSC 103 in step S139. The S-BSC 103 terminates an operation of the Trel9 timer.

Then, the S-BSC 103 transmits a Clear Complete message to the MSC 111 in step S141.

In step S143, the S-PDSN 121 initializes the closure of the A10 Connection with the S-PCF 105 by sending an All-Registration Update message to the S-PCF 105.

The S-PCF 105 provides the S-PDSN 121 with an All-Registration Ack message as a response in step S145. Further, the S-PCF 105 sets a lifetime to 0 and transmits an All-Registration Request message and accounting related information to the S-PDSN 121 in step S147.

The S-PDSN 121 stores the received accounting related information for a subsequent process and sends an All-Registration Reply message to the S-PCF 105 in step S149. Meanwhile, the S-PCF 105 closes the A10 Connection for the MS 101.

In step S151, the T-PCF 109 provides an All-Registration Request message to the T-PDSN 123 so as to update the registration of the A10 Connection to the T-PDSN 123. The All-Registration Request message is used in transmitting the accounting related information and other information and the accounting related information and the other information are transmitted at a system defined trigger point.

For the verified All-Registration Request message, the T-PDSN 123 transmits the All-Registration Reply message together with the accept indication and the determined lifetime in step S153.

Referring to FIG. 2, there is shown a flow diagram depicting a PPP re-establishment and MIP re-registration procedure described in FIG. 1. As illustrated in FIG. 2, the T-PDSN 123 establishes a PPP session with the MS 101 and a PPP authentication is not used for an MIP service. After initializing the PPP, the T-PDSN 123 transmits an Agent Advertisement message to the MS 101 and the MS 101 also sends an Agent Solicitation message to the T-PDSN 123.

The MS 101 generates an MIP Registration Request message to the packet network. The T-PDSN 123 packetizes the Registration Request message provided from the MS 101 by using an AAA protocol to thereby produce an AA-Mobile-Node Request (AMR) message to a local AAA RADIUS server (AAA-L). The local AAA server uses a network access ID (NAI) so as to transmit the AMR message to an appropriate home AAA server (AAA-H). The AMR message is totally transmitted by using a security association (SA) between a visiting network and a home network.

The AAA-H verifies a location of a home agent (HA) by using an HA IP address of a mobile node and re-packetizes the AMR message to produce a Home-Agent-MIP-Request (HAR) message. The HA processes the MIP registration procedure of the MS 101 and generates a Home-Agent-MIP-Registration-Answer (HAA) to the AAA-H.

The AAA-H packetizes the HAA message to produce an AA-Mobile-Node-Answer (AMA) to the local AAA server (AAA-L).

The local AAA server transmits the AMA to the T-PDSN 123.

The T-PDSN 123 generates an MIP Registration Reply message to the MS 101.

If user data are actuated between the MS 101 and the PDSN by using the PPP session, it is possible to transmit AAA interim accounting records to the local AAA server (AAA-L) and proxy them to the home AAA server (AAA-H).

As described above, according to the inter-PDSN hard handoff procedure of the prior art, during the steps S111 to S134 being performed, the data transmitted from the S-PDSN 121 are not delivered to users, i.e., the MS 101. Moreover, since there exist an A8 and A10 connection time between nodes and a PPP re-establishing and MIP re-registering time between the MS 101 and the T-PDSN 123, there occurs a substantially large time delay.

Therefore, in order to prevent data loss due to the time delay, there need regular doses of buffers in a node. However, although there are prepared the buffers, in case a size of data stored in the buffers exceeds the capacity of the buffers, there inevitably occurs a severe problem of causing the data loss.

That is, there is a problem that the existing inter-PDSN hard handoff performing method employed in the third generation IMT-2000 synchronous packet data network is improper to processing the packet data requiring fast transmission without data loss, i.e., real-time services.

Specifically, since the hard handoff performing method defined in the third generation synchronous IMT-2000 wireless packet network cannot provide fast and seamless real-time services since there is the time delay when the handoff is performed in the active mode, it is difficult to provide real-time audio/video packet data services such as VoIP.

### SUMMARY OF THE INVENTION

It is, therefore, a primary object of the present invention to provide an inter-PDSN hard handoff performing method capable of providing a fast inter-packet data service without data loss by establishing a link between BSCs via an MSC in case of an active packet session mode in a third generation synchronous IMT-2000 wireless packet communication network.

In accordance with the present invention, there is provided a method for performing an inter-packet data service node (PDSN) hard handoff, comprising the steps of: setting up a channel link passing through a target base station controller (T-BSC), a source base station controller (S-BSC), a source packet control function (S-PCF) and a source-PDSN (S-PDSN) by establishing a channel link between the S-BSC and the T-BSC via a mobile station center (MSC) in an active packet session mode; performing the hard handoff between the S-BSC, the T-BSC and a mobile station (MS); and transmitting or receiving user packet data exchanged between the MS and the T-BSC through the established channel link to or from the S-PDSN in case the hard handoff is completed.

In accordance with the present invention, it is possible to perform a packet hard handoff without packet data loss by reducing a time delay caused in a handoff procedure performed during a packet data session of an active mode in an inter-PDSN.

In particular, in case it is impossible to directly establish a link between a T-BSC and an S-BSC measuring a power strength of a wireless signal transmitted from an MS in the active mode, the hard handoff is performed by establishing a link between the S-BSC and an MSC by transmitting a circuit identification code (CIC) of the S-BSC when the S-BSC sends a Handoff Required message to the MSC and, meanwhile, establishing a link between the T-BSC and the MSC by transmitting a CIC of the MSC when the MSC sends a Handoff Request message to the T-BSC.

Therefore, during performing the hard handoff procedure in the active mode, the S-BSC can continuously maintain a link with an S-PCF as an anchor and transmit packets to the MS.

Furthermore, when the inventive hard handoff procedure is completed, by establishing a link between the T-BSC, a T-PCF and the T-PDSN after being converted to a dormant mode, it is possible to provide packet data services in a next active mode without data loss and time delay due to the link establishment and the PPP/MIP re-establishment/re-registration.

### BRIEF DESCRIPTION OF THE DRAWINGS

The above and other objects and features of the present invention will become apparent from the following description of preferred embodiments given in conjunction with the accompanying drawings, in which:

FIG. 1 provides a call-processing flow diagram showing an inter-PDSN hard handoff procedure defined in IS-835 and IOS V4.x;

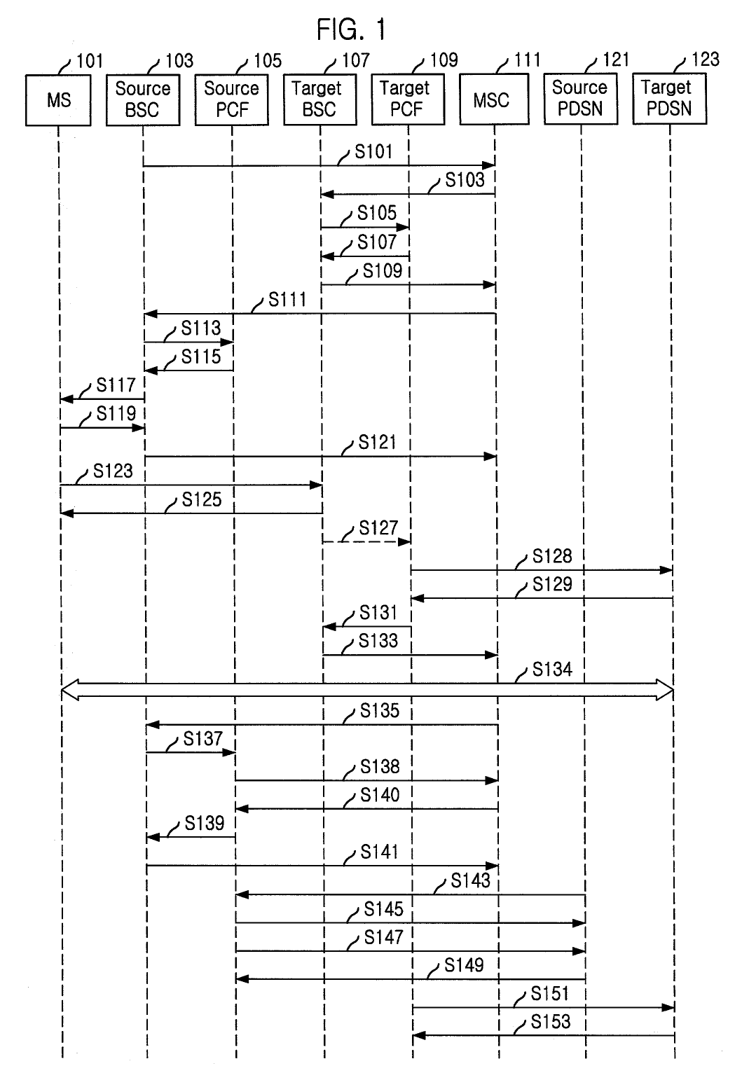

FIG. 2 shows a flow diagram representing a PPP re-establishment and MIP re-registration procedure described in FIG. 1;

FIG. 3 describes a call-processing flow diagram representing an inter-PDSN hard handoff procedure in accordance with the present invention;

FIG. 4 is a conceptual diagram depicting a link established between BSCs via an MSC when performing an inter-PDSN hard handoff in an active mode in accordance with the present invention; and

FIG. 5 illustrates a conceptual diagram showing a flow of packet data transmitted through a link established between an S-BSC and a T-BSC via an MSC when performing an inter-PDSN hard handoff in an active mode in accordance with the present invention.

### DETAILED DESCRIPTION OF THE INVENTION

Hereinafter, with reference to the accompanying drawings, some preferred embodiments of the present invention would be explained in detail. Hereinafter, when assigning reference numerals to components constructing each drawing, same components are represented by an identical reference numeral although they are shown in different drawings.

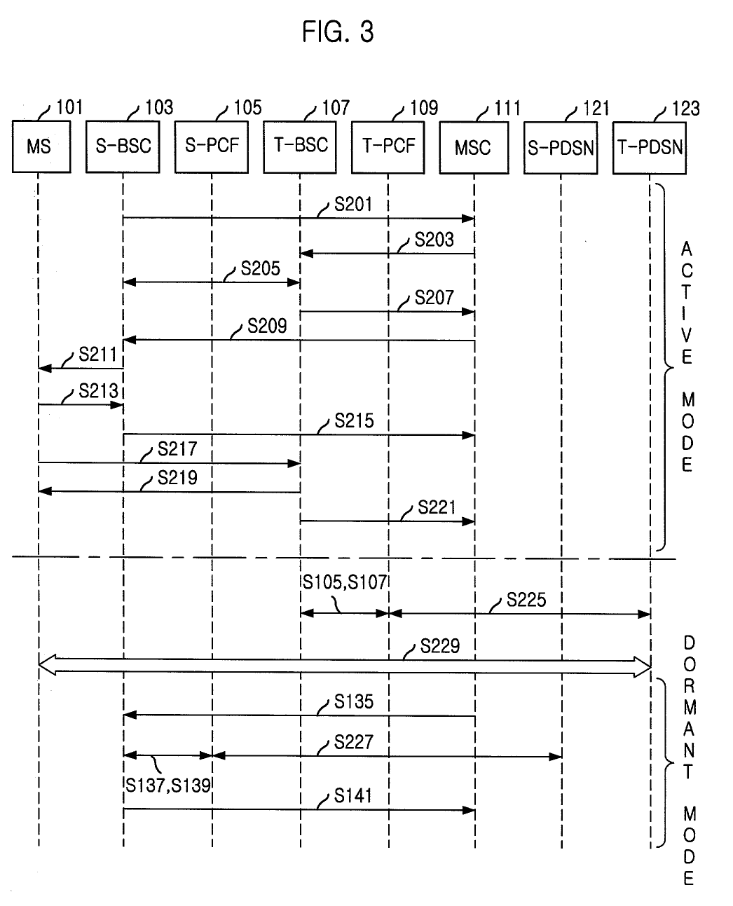

Referring to FIG. 3, there is illustrated a procedure rapidly supporting an inter-PDSN hard handoff without data loss by establishing a link between BSCs via an MSC in an active mode of a synchronous IMT-2000 wireless packet network. FIG. 3 describes a call-processing flow diagram representing the inter-PDSN hard handoff procedure in accordance with the present invention.

When a message showing that a signal strength of a mobile station (MS) 101 became over a given signal strength threshold defined in a network and the MS 101 will convert to another access network identifier (ANID) is transmitted from the MS 101 to a S-BSC 103, the S-BSC 103 sends a Handoff Required message including a cell list within a domain of a T-BSC 107 to an MSC 111 in step S201 and actuates a T7 timer. The Handoff Required message contains a previous ANID (PANID).

Further, the Handoff Required message includes a circuit identification code (CIC) value delivering call resources of the S-BSC 103 as an extender.

The MSC 111 selects the T-BSC 107 having an available wireless channel from the cell list, adds the PANID and a hard handoff indicator to a Handoff Request message and transmits the Handoff Request message to the T-BSC 107 in step S203. The Handoff Request message contains a CIC value therein.

In step S205, the T-BSC 107 establishes an ATM-based link channel via the MSC 111 between the S-BSC 103 and the T-BSC 107 by allocating appropriate idle wireless resources as receiving the Handoff Request message. Meanwhile, a S-PDSN 121 continuously transmits forward packet data to the S-BSC 103 through an S-PCF 105.

Moreover, the T-BSC 107 transfers null traffic channel data to the MS 101 through a forward traffic channel.

Then, in step S207, the T-BSC 107 allows the MS 101 to be tuned to a corresponding wireless channel by transmitting a Handoff Request Ack message including appropriate wireless channel information to the MSC 111 and actuates a T9 timer so as to wait for the signal receiving from the MS 101 through the corresponding wireless channel.

In accordance with the present invention, although the hard handoff is performed in the active mode, there are not performed an A8/A9 Connection process and a PPP/MIP re-establishing/re-registering process between the T-BSC 107 and a T-PCF 109 and the A8/A9 Connection and PPP/MIP re-establishing/re-registering process will be executed in a dormant mode as described herein below.

The MSC 111, which received the Handoff Request Ack message, prepares a call switching from the S-BSC 105 to the T-BSC 107 and sends a Handoff Command message including the wireless channel information provided from the T-BSC 107 to the S-BSC 103 in step S209. Then, the S-BSC 103 terminates an operation of the T7 timer.

In step S211, the S-BSC 103 transmits a general handoff direction message (GHDM) or a universal handoff direction message (UHDM) to the MS 101 and actuates a Twaitho timer so as to allow the MS 101 to return to the S-BSC 103.

The MS 101 provides the S-BSC 103 with an MS Ack Order message as a response to the GHDM or UHDM in step S213.

In step S215, the S-BSC 103 sends a Handoff Commenced message to the MSC 111 so as to notify that the MS 101 is instructed to move to a channel of the T-BSC 107. The Handoff Commenced message is transmitted after an operation of the Twaitho timer is terminated.

If the MS 101 completes the hard handoff procedure by obtaining synchronization through the use of a backward communication channel frame or preamble data, the MS 101 transmits a Handoff Completion message to the T-BSC 107 in step S217 and the T-BSC 107 which received the Handoff Completion message transmits a BSC Ack Order message to the MS 101 in step S219.

In step S221, after the T-BSC 107, which received the Handoff Completion message, detects that the MS 101 is connected to the T-BSC 107, the T-BSC 107 transmits a Handoff Complete message to the MSC 111 so as to notify that the hard handoff is successfully performed for the MS 101 and terminates an operation of the T9 timer.

After then, user packet data transmitted from the MS 101 are delivered to the S-BSC 103 via the T-BSC 107 and the MSC 111. At this time, the S-BSC 103 exists as an anchor and continuously transmits packet data to the other node of the wireless packet data network through the S-PCF 105 and the S-PDSN 121 until the active mode is converted to the dormant mode. Likewise, the packet data arrived at the MS 101 from the other node are delivered in an order of the S-PDSN 121, the S-PCF 105, the S-BSC 103, the MSC 111 and the T-BSC 107.

Therefore, since the S-BSC 103 plays a role of the anchor, there is no need to re-establish the A8/A9 Connection between the T-BSC 107 and the T-PCF 109 and the A10/A11 Connection between the T-PCF 109 and the T-PDSN 123, respectively.

Further, the PPP/MIP re-establishing/re-registering process is omitted. As a result, it is possible to prevent a time delay required in establishing a link and performing the PPP/MIP re-establishing/re-registering process in the conventional handoff scheme.

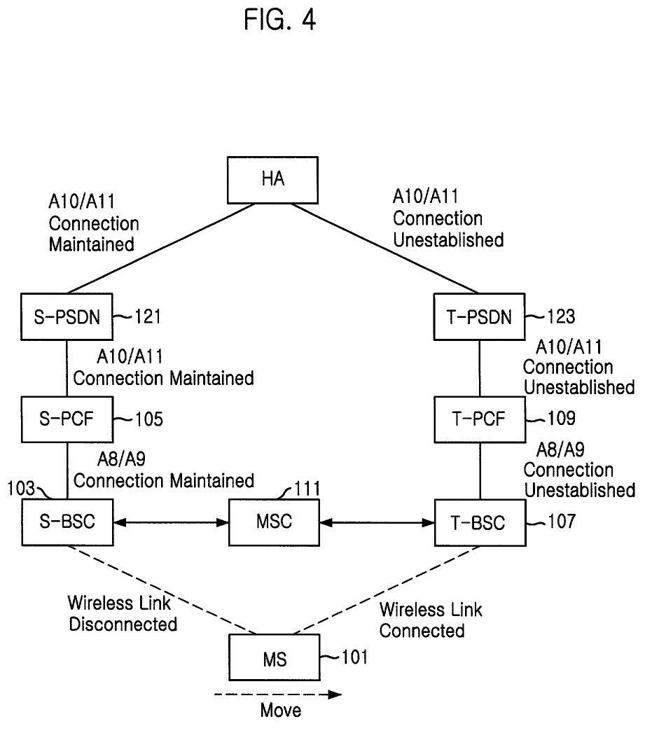

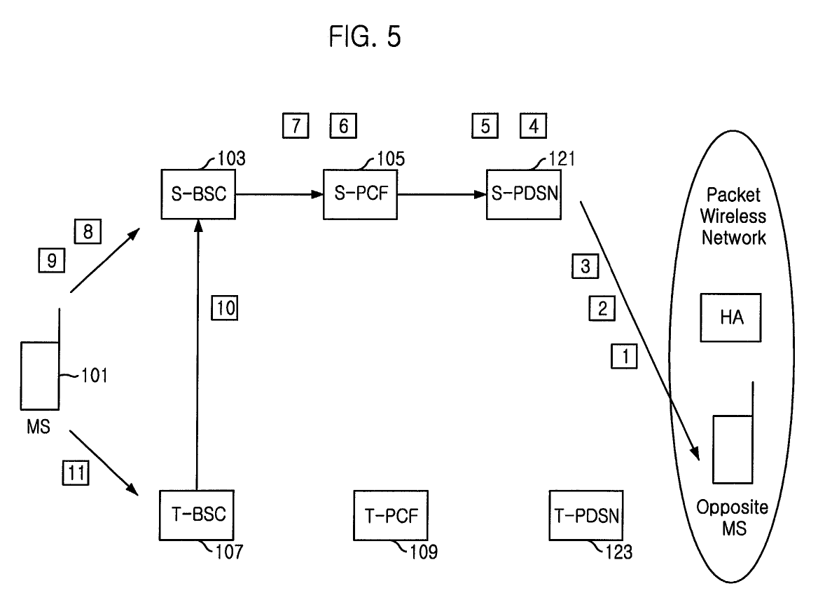

Referring to FIG. 4, there is shown a conceptual diagram depicting a link established between BSCs via an MSC when performing the inter-PDSN hard handoff in the active mode in accordance with the present invention. FIG. 5 illustrates a conceptual diagram showing a flow of packet data transmitted through a link established between an S-BSC and a T-BSC via an MSC when performing the inter-PDSN hard handoff in the active mode in accordance with the present invention. In FIG. 5, reference numerals 1 to 9 represent a flow of data packets before the handoff and reference numerals 10 and 11 describe a flow of data packets after the handoff.

As illustrated in FIGS. 3 to 5, since there is already established a channel link between the S-BSC 103 and the T-BSC 107 via the MSC 111 and the S-BSC 103 is determined as an anchor although the hard handoff of the inter-PDSN is executed in the active mode by performing the above handoff procedure in accordance with the present invention, it is possible to transmit the packet data to the wireless packet data network through the S-PCF 105 and the PDSN 121 by the channel link to the S-BSC 103 established via the MSC 111 even though packet data are exchanged through a wireless link established between the MS 101 and the T-BSC 107 by executing the hard handoff.

Accordingly, since the process for establishing the A8/A9/A10/A11 Connection between the T-BSC 107, the T-PCF 109 and the T-PDSN 123 and the PPP/MIP re-establishing/re-registering process are omitted, the time delay due to the hard handoff is substantially reduced and, thus, it is possible to provide seamless fast packet data services.

The process for setting up the A8/A9/A10/A11 Connection between the T-BSC 107, the T-PCF 109 and the T-PDSN 123 and the PPP/MIP re-establishing/re-registering process are performed in the dormant mode described herein below.

As depicted in FIG. 3, after the T-BSC 107 detects that there is no packet data provided from the MS 101 or the S-BSC 103 anymore by actuating a timer, the active mode is converted to the dormant mode. Then, in order to set up the A8-Connection with the T-PCF 109, an A9-Setup-A8 message is transmitted to the T-PCF 109 and a TA8-Setup timer is actuated in step S105.

The T-PCF 109, which received the A9-Setup-A8 message, sets up the A8-Connection and, then, provides an A9-Connect-A8 message to the T-BSC 107 in step S107. Meanwhile, the T-BSC 107, which received the A9-Connect-A8 message, stops an operation of the TA8-Setup timer.

Furthermore, there is established an A10/A11 Connection between the T-PCF 109 and the PDSN 121 in step S225. As a result, the A8/A9/A10/A11 Connection is set up between the MS 101, the T-BSC 107, the T-PCF 109 and the T-PDSN 123.

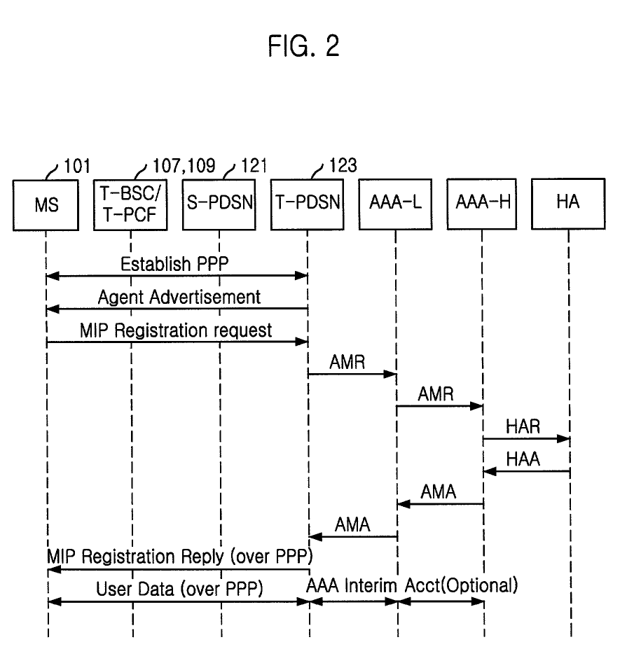

Then, as shown in FIG. 2, a PPP link layer connection is set up between the MS 101 and the T-PDSN 123 and the MIP registering procedure is performed between the wireless packet network and the MS 101 in step S229. If the registration is completed, the user packet data are exchanged between the MS 101 and an opposite MS through the A10 Connection.

In step S135, the MSC 111 supplies a Clear Command message to the S-BSC 105 and the MSC 111 actuates a T315 timer.

The S-BSC 103 transmits an A9-Release-A8 message to the S-PCF 105 so as to release the A8-Connection with the S-PCF 105 and actuates a Trel9 timer in step S137.

The S-PCF 105 releases the A8-Connection and generates an A9-Release-A8 Complete message as a response in step S139. The S-BSC 103 terminates an operation of the Trel9 timer.

Then, the A10 Connection between the S-PCF 105 and the S-PDSN 121 is released and its state is updated in step S227.

Finally, the S-BSC 103 provides the MSC 111 with a Clear Complete message to thereby terminate the inter-PDSN hard handoff procedure in step S141.

According to the hard handoff procedure in accordance with the present invention, a CIC is used as an extender when the S-BSC 103 transmits the Handoff Required message to the MSC 111 in the active mode and transmitted when the MSC 111 sends the Handoff Request message to the T-BSC 107 to thereby establish a link between BSCs via the MSC 111, so that the hard handoff procedure can support the hard handoff by using the communication between the BSCs.

When the handoff occurs, packet data transmitted from the MS 101 to the T-BSC 107 are provided to the S-BSC 103 through a channel link established by the CIC and transmitted to the wireless packet data network through the S-PCF 105 and the S-PDSN 121.

Herein, the S-BSC 103 plays a role of the anchor in the active mode to thereby allow the packet data passing through the T-BSC 107 to go through not the T-PCF 109 but the S-BSC 103 although the handoff occurs, so that the time delay due to the A8/A9/A10/A11 Connection and the PPP/MIP re-establishing/re-registering process between the MS 101, the T-BSC 107, the T-PCF 109 and the T-PDSN 123 is reduced.

After executing the handoff, the anchor state of the S-BSC 103 is released in the dormant mode.

After the handoff, when the MS 101 existing at the cell domain of the T-BSC 107 is converted to the dormant mode, by setting up the A8/A9 Connection between the T-BSC 107 and the T-PCF 109 and the A10/A11 Connection between the T-PCF 109 and the T-PDSN 123 and performing the PPP/MIP re-establishing/reregistering process, there is no need to newly establish the A8/A9/A10/A11 Connection and to perform the PPP/MIP re-establishing/re-registering process when the dormant mode is converted to the active mode again. As a result, it is possible to reduce the time delay caused by the link establishment.

Accordingly, compared to the prior art, the present invention can provide the packet data services without a break and data loss.

As described above, the inventive handoff performing method can support the handoff without a break by performing the fast hard handoff in the packet wireless communication network.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method for performing an inter-packet data service node (PDSN) hard handoff, comprising the steps of:
(a) setting up a channel link passing through a target base station controller (T-BSC), a source base station controller (S-BSC), a source packet control function (S-PCF) and a source-PDSN (S-PDSN) by establishing a channel link between the S-BSC and the T-BSC via a mobile station center (MSC) in an active packet session mode;
(b) performing the hard handoff between the S-BSC, the T-BSC and a mobile station (MS); and
(c) transmitting or receiving user packet data exchanged between the MS and the T-BSC through the established channel link to or from the S-PDSN in case the hard handoff is completed.

2. The method according to claim 1, further comprising the steps of:
(d) establishing a channel link between the T-BSC, a target packet control function (T-PCF) and a target-PDSN (T-PDSN) in a dormant packet session mode;
(e) releasing the channel link set up between the S-BSC, the S-PCF and the S-PDSN;
(f) releasing the channel link established between the S-BSC and the MSC, which is set up in the step (a); and
(g) performing a point-to-point (PPP) establishing process and a mobile Internet protocol (MIP) registering process between the MS and the T-PDSN.

3. The method according to claim 1, wherein the step (a) includes the step of:
(a1) transmitting a Handoff Required message from the S-BSC to the MSC and establishing the channel link between the S-BSC and the MSC.

4. The method according to claim 3, wherein, in the step (a1) the channel link between the S-BSC and the MSC is established by including a circuit identification code (CIC) as an extender in the Handoff Required message.

5. The method according to claim 1, wherein the step (a) includes the step of:
(a2) transmitting a Handoff Request message from the MSC to the T-BSC and establishing the channel link between the MSC and the T-BSC.

6. The method according to claim 5, wherein, in the step (a2), the channel link between the MSC and the T-BSC is set up by including a circuit identification code (CIC) as an extender in the Handoff Request message.
